(19) United States
(12) Patent Application Publication
(10) Pub. No.: US 2023/0381655 A1
(43) Pub. Date: Nov. 30, 2023

(54) High Definition American Football Video Game

(71) Applicants: Ronaldo Cordero Navarro, Hacienda Heights, CA (US); Jocelyn Co, Chino, CA (US)

(72) Inventors: Ronaldo Cordero Navarro, Hacienda Heights, CA (US); Jocelyn Co, Chino, CA (US)

(21) Appl. No.: 18/326,958

(22) Filed: May 31, 2023

Related U.S. Application Data
(60) Provisional application No. 63/347,243, filed on May 31, 2022.

(51) Int. Cl. A63F 13/56; A63F 13/812; A63F 13/63; A63F 13/34; A63F 13/52

(52) U.S. Cl. CPC A63F 13/56; A63F 13/812; A63F 13/63; A63F 13/34; A63F 13/52; A63F 13/497

(57) ABSTRACT

While entertainment grade video games thrive in an ever-growing video game market, video games that focus on learning maintain their intrinsic value in terms of intellect and knowledge. Target players for educational games do not often represent the mainstream population of gamers, and vice versa. Bridging such gap may present the risks of diluting the commercial appeal of highly popular game titles. Real-time rendering, the natural partner of popular games, remains a burden on computational resource budgeting. This project proposes to mitigate animation detailing to accentuate the sports simulation video game of American Football with fluid lifelike motions by utilizing objective assessment structure for game control to combine competition, education, and gaming entertainment.

### RELATED U.S. APPLICATION DATA

This application claims the benefit of U.S. Provisional Application No. 63/347,243 filed on May 31, 2022. U.S. Provisional Application No. 63/347,243 is hereby incorporated by reference in its entirety.

### BACKGROUND

### 1. Field of Invention

The various aspects discussed herein relate to a sports-simulated video game

### 2. Description of Related Art

Primary intrinsic motivation and value of sports-simulated video games center on the context of entertainment. However, there are problems with said sports-simulation video games.

### BRIEF SUMMARY OF THE INVENTION

The popularity of video games reflect a huge industry. Open Science Data indicates its intrinsic value equating predominantly to entertainment. This disclosure proposes to leverage aspects described herein along with the pronounced commercial appeal of video games to present a type of sports-simulated video game that could potentially address broader impacts.

In aspects described herein, a high definition sports simulation game is disclosed. The high definition sports-simulation game may have a process of of adapting the characteristics of the game of American football as preferred embodiment of said sports simulation video game, a process for enabling one or more users, a library of scripted pre-rendered animated gameplays, a process for pre-game settings, a control implement, a process for category selection, a process for triggering specific gameplay playback, game controlling device, and an educational implement.

With respect to the process for enabling number of user(s), the selection for one user would configure the game session for said user to compete against the computer, while the selection for more than one user would configure the game session for competition between the participating users.

The gameplay library may contain a collection of scripted pre-rendered gameplays that may be produced from techniques that are not subject to constraints of real-time rendering, enabling said pre-rendering technique to feature necessary graphical animation variables in effecting fluid life-like motion representation of said gameplays. The gameplays may be additionally organized by a collection of categories, whereby each category from said collection of categories may represent variations of gameplay outcomes depicting specific net yardage and whereby the categories may range from −99 yards, or maximum yardage that can be lost, to 100 yards, or the maximum yardage that can be gained, respectively on any one given play. Additionally the gameplays may be represented with respective pre-scripted text-to-speech content to depict voice-over narration per respective said gameplays, whereby said pre-scripted text-to-speech content may contain variable spaces reserved to correspond with values per said user(s) inputs per pre-game setup, per game session.

The pregame settings may prompt or enable said user or users to input pre-game selection settings for purposes of game setup that may include, but not limited to, 3d character characteristics or properties, respective uniforms of said 3d characters, uniform numbers of said respective uniforms, and may additionally include said user(s) input of names for specific 3d characters that are associated with game-defined positions associated with ball handling such as quarterback, running back, receivers. intended to fit respective voice-over narration per respective gameplay contained in said library.

The control implement may feature an objective assessment format with a stem question and at least one correct answer and at least one plausible alternative, with said control implement recurring with a different display of context at stoppage of every gameplay per gaming session.

The process for category selection may prompt or enable competing users for consentaneous selection of a subject category coordinated with an objective assessment format characterized by Multiple-Choice-Question structure, whereby categories and content may include educational content for fostering learning.

The process for triggering playback of gameplays may involve assessment, evaluation and weighing of answers per instance of said objective assessment, taking into account, answer correctness, answer completeness, promptitude, current field position, and respective quantification of said answers with relation to correctness and/or incorrectness of said answers, with the resulting gameplay being commensurate to the score differential, whereby the bigger the difference, the bigger the net yardage to be depicted in respective gameplay wherein the maximum difference may be equated with up to 100 yards, which could further translate to a possible net yardage ranging from 100 yards, or maximum yardage that could be gained, to −99 yards, or maximum yardage that could be lost, as respective of commensurate depiction.

The controller(s) may be wired devices or wireless devices as interface that said user(s) may utilize for facilitation of said control implement and submit inputs.

With respect to the educational implement, said implement may enable user(s) for input towards objective assessment questions that foster learning

Effecting the spontaneous characteristics of viewing a live football game by means of combined realistic animation with a controlling element, defining it as a game, and with the controlling element representative of an educational implement, a commercial appeal of an educational video game may be established.

### BRIEF DESCRIPTION OF THE DRAWINGS

FIG. 1A depicts a partial view of one embodiment of the system in which aspects involved with the game's linear game flow is illustrated

FIG. 1B depicts the accompanying partial view of the same embodiment of the system in which additional aspects involved with the game's linear game flow is illustrated.

FIG. 2 lists processes involved in the animation rendering/game settings/general directory details.

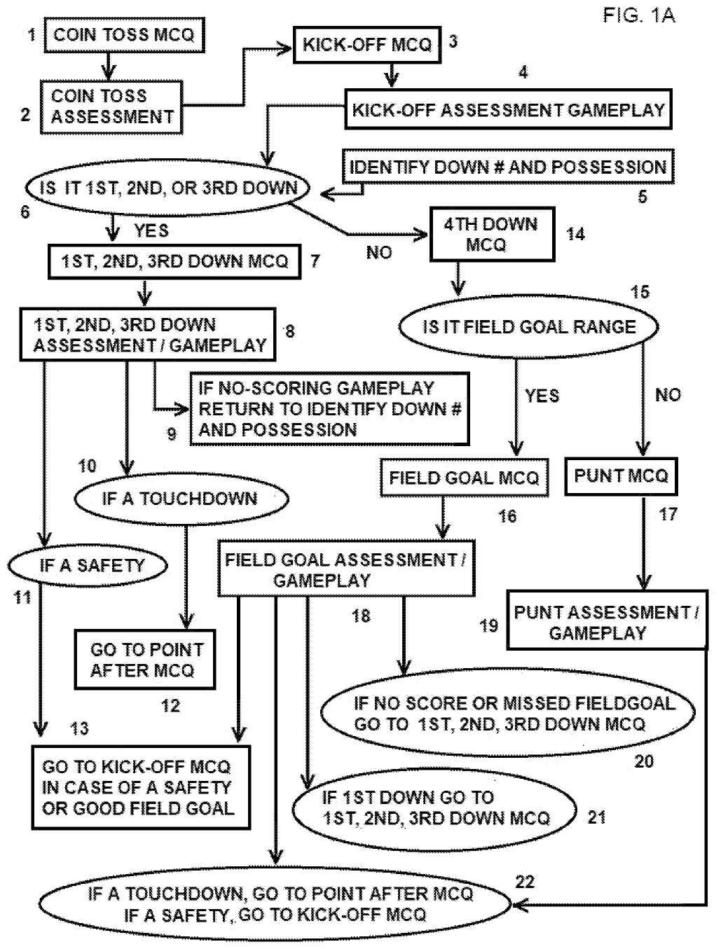

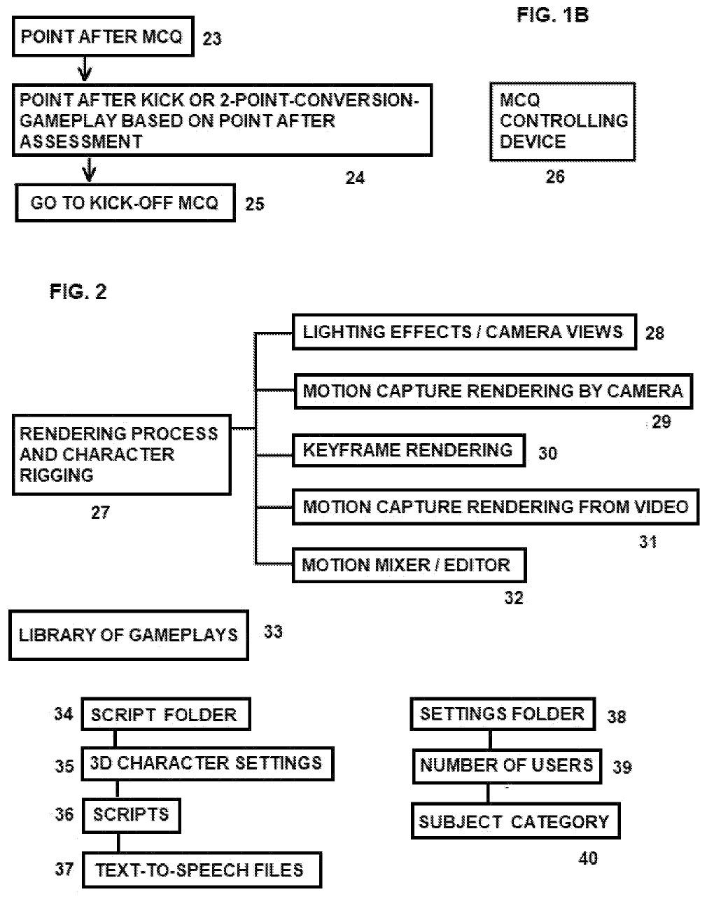

### DETAILED DESCRIPTION

Disciplines in animation popularly involve real-time rendering (for gaming engines) and scripted pre-rendered animation (for movie rendering engines). Gaming engines and rendering engines share the same principles involving creation of 3d animation characters. The use of skeletal structure fused with a 3d character wherein the framed 3d character movements are catalyzed by motion data mapped and synchronized with its skeletal structure.

However, their respective rendering processes contradict. Gaming software, especially sports simulation games, are mostly associated with real-time rendering in correlation to operation protocols that center on interactive input. Movie animation is associated with scripted pre-rendered animation in correlation to production of rich animation details not subject to real-time rendering constraints and benefiting from generous computational resource budgeting.

Game applications' inherent feature of user real-time interaction requires a real-time frame-by-frame rendering process for instantaneously interpreting user input that is intended to correlate or simulate human motion, especially sports-simulation games. This process is subject to constraints of real-time rendering with limited motion data for addressing technical risks of endless animation variables that are further compounded by variations from character to character, to represent realistic fluid gameplay scenes. These constraints effect with generalized motion interpretation due to limitation of motion profile references, and may resemble mechanical movements attributed to the technical risks associated with endless variations of animation variables.

Though simulations are compromised with mathematical impossibility effecting with generalized motion definitions and with representations of mechanical motion, resourceful computational resource budgeting by gaming engines' real-time rendering structure contributes pronouncedly to incremental and non-incremental innovations in real-time animation.

Without constraints of real-time rendering, movie animations benefit with high levels of details from the necessary animation variables to lighting effects and clothing details in depicting fluid animation and realistic scenes. Sports simulation video games aspire to featuring as much details as possible with frame by frame interaction, but scripted pre-rendered animation suggest a mismatched proposition concerning real-time controls and interaction.

Lifelike motion may not be for every video game, but the genre of sports simulation video games, and sports simulation video games depicting the game of Professional American Football could benefit from animation optimization depicting fluid motion that is possible with scripted pre-rendered animation. Such effects could enhance its commercial appeal and further raise its entertainment intrinsic value. A controlling implement could be integrated or featured with the use of objective assessment format and represented prompts that, hereinafter referred to as MCQ (for Multiple Choice Question Format) is not reliant on frame-by-frame interaction. Furthermore, an objective assessment format such as said MCQ as a control implement could be leveraged to being an educational tool by featuring educational content. This could effect with an elevated intrinsic value that addresses broader impacts.

With commercial appeal of professional sports as represented by sports simulation video games, especially games representing American Football, disclosed herein are aspects of a high definition sports simulation video game, hereinafter referred to as video game, representing American Football that proposes a departure from required dexterity of physical means of operation involving hand-eye coordination. And instead, with suggestion of direction and control of game flow involving said video game by means of intellectual dexterity through the use of educational content in conjunction with said mcq format, to potentially serve as leverage in accentuating a popular sport.

Said MCQ format as controlling implement may be operated and represented by either wired controlling devices or wireless devices over a client-server application. Additionally, said video game may be operated on a multi-player or multi-user setting that would enable representation of multiple players per team, per game session, through consentaneous aggregation of respective answers.

Aspects of animation process for creation of scripted pre-rendered gameplays may include:

Character Rigging 27, which is the method of creating a “skeleton” for a 3D model to be manipulated and animated when integrated with motion data or motion capture data. It involves graphical setup that enables definition of range of movements of joint areas from head to toe.

Motion Capture by Keyframing 30, which denotes starting frame and ending frame of projected motion, whereby respective motion per 3d character is defined as logical sequences of keyframes that are graphically set, whereby interpolation values between keyframes, for correlating time and speed are digitally generated to automatically define the frames within the key frames, intended of translating into smoothness between the respective start and end frames.

Motion Capture (markerless) by Camera 29, the process of recording or capturing movements by camera and without physical marker sensors, of one or more subjects which are translates into motion data that can be merged into said skeleton structure, and enabling animation, for respective 3d Characters.

Motion Capture (markerless) from video 31, the process of recording or capturing movements from reference video footage, of at least one subject and translates into motion data that can be merged into said skeleton structure, and enabling animation, for respective 3d Characters.

To depict natural fluid motion, gameplays may be replicated from reference footage representing authentic motion involved in football. Motion data may be replicated by keyframe rendering 30 on a per character basis from reference footage imported into respective 3d characters, and later merged with other characters into gameplay scenes.

Motion data captured by camera 29 from live action may be retargeted or fused into respective 3d characters to translate into animation involving single or multiple characters at a time for assembly into a complete gameplay scene with the live action as basis of reference. Motion data captured by camera 29 from live action may also be used to replicate a documented reference footage depicting authentic motion.

Regarding said video game, the aforementioned aspects 27 thru 32, may be utilized in any combination to serve as essential tools in creating high fidelity animation gameplays replicated from reference footage with authentic motion while abstracting out the least essential details when necessary, to mitigate computational resource budgeting, per gameplay, with emphasis on presenting optimum motion fidelity. Additionally, gameplay rendering processes may include lighting effects, and different camera views for further graphical enhancement or optimization.

For efficient production and editing of motion capture data, motion capture data may be recycled and edited into new definitions as necessary for replication of video reference footages. For further editing versatility, a motion mixer/editor 32 may be used to mix motion capture data. The concept of the Motion Mixer is based on audio mixing done in the music and sound editing. Like an audio mixer, Motion Mixer lets you add a series of tracks for each object or 3d character in a scene. Even filtering processes are available for smooth linking of motion capture data.

As the rendering technique involves a layered process with creation of gameplays independent of background and middleground assets such as the graphical display of the playing field, the game algorithm upon playback trigger, pans the graphical representation of the playing field to merge respective gameplay to the active field position.

Highlighting the professional sport of American football involving its features include:

A playing field represented with 100 yards in length, with yardline markings, and goal posts at each end zone;
Participated by two opposing teams whose respective goals are to score the higher points through touchdowns, field goals, safeties, 2 point conversions and extra points after touchdown;
The 2 teams with cyclical and alternating roles depicting offense and defense;
With the rule that enables the team with possession of the ball of scoring opportunity,
The offensive team being the team with ball possession aiming to advance towards the opponent's end zone with the aim of the defense of countering while also aiming to take possession of the ball;
The offensive team having 4 downs or plays to score or advance at least 10 yards to renew another series of 4 downs;
Playing duration of 60 minutes distributed in 4 quarters with respective alternating ball possession assignments per half or 2 quarters;
And with continuous game clock only interrupted by penalty calls, timeouts, out-of-bounds plays, ball possession change;
And gameplay clock that runs for 40 seconds after every stoppage.

Participating players involved with said sports simulation video game would be referred to, hereinafter, as user and/or users.

The algorithm and rendering techniques supported by said video game translates the rules, features, and characteristics of the sport of American Football into a high fidelity animated game without the predictability of interactive control, to simulate a live game viewing environment.

Although the game algorithm and library of scripted pre-rendered gameplays combine to provide capacity of presenting gameplays that involve net yardage of −99 to 100 yards and combinations in between, probability and outcome per mcq cycle are influenced and controlled by users' mcq answering proficiency. Computational definitions factor respective users' mcq responses, taking into account mcq answer correctness, mcq answer completeness, mcq retracing, and promptitude (relating to the time limit of 40 seconds per mcq set), scoring differences, and current field position to determine and trigger a commensurate gameplay.

The MCQ prompts serving as front end control implement interface 26 delivers and displays the stem questions in cyclical sets of 4 with each question stem respectively containing 4 answers, of which, at least 1 is the correct answer supplemented by plausible distractors or incorrect answers. Said MCQ prompts are represented in variations such as 4th Down MCQ 14, 1st 2nd 3rd Down MCQ 7, Field Goal MCQ 16, Punt MCQ 17, Kick-off MCQ 3, and Point-After MCQ 23 to pre-define parameters analyzed by the game algorithm of said video game in determining the game flow and upcoming corresponding type of gameplay. Thus, when the game flow calls the 1st 2nd 3rd Down MCQ 7, it signals the algorithm that a kicking gameplay will not be included in the next computation in determining the type of gameplay, and so on.

With high-fidelity animation central to said video game's format, a library 38 of scripted pre-rendered gameplays, stored on the server executing said video game, would serve as reservoir from which the game would draw a specific gameplay warranted per algorithmic assessment of users' performance toward each set of respective mcq prompts, serving as the game's catalyst or controlling implement

Gameplays would be depicted categorically according to net yardage ranging from positive 100 yards to −99 yards. Whereby each category would entail variations for further representation of realism involved for simulating a live game view presentation.)

As said gameplays are net yardage specific, depictions of gameplays with penalty situations would be factored in into said gameplays involving penalties for the purpose of presenting additional granular effects for simulating a live game presentation As the scripted pre-rendered gameplays would be maintained in an ever expanding shared library whereby versions can be managed and updated by users and would maintain neutral properties in terms of uniform related characteristics subject to customization during run time, according to pre-game user-defined settings.

Aspects described herein illustrates the pre-game setup stored on the settings folder 38 for said video game.

A game session would involve a setup process that would prompt for the number of players 39. With the game of football featuring two opposing teams, in a setting involving multi-user setup, a team may be represented by a user or group of users. An opposing team may be represented by another user or group of users.

A single user setup may involve a user or users to represent one team, while the computer would represent the opposing team. With single player setting, additional setting for selecting values for level of difficulty would represent the levels for: Easy; Moderate; and Challenging. In reflecting these modes, the computer performance levels, with respect to the mcq feature serving as controlling implement, would represent the average score generation of 40%, 70%, and 90%, to correspond to the levels of Easy, Moderate, and Challenging, respectively.

The pre-game setup for character settings 35 or properties may include: selection of uniforms and numbering details; and characteristics. These settings are stored in the script folder 34 for their dynamic properties, instead of the settings folder 38, used for static settings.

Additional pre-game setup 35 involves name assignments and respective positions for 3d characters representing playing positions that are associated with ball handling for the purpose of value assignment to variables in text-to-speech 37 content for accompanying voice over narration per scripted gameplay.

Further pre-game setup involves selecting a subject or topic category 45 whose respective context would be represented in the game session's mcq prompts.

With the cyclical structure involving mcq prompts recurring at every game stoppage or conclusion of a gameplay, one representation of an algorithm flow involved in assessing mcq score, herein, is illustrated.

MCQ prompts would be cyclical and would activate at every game stoppage to provide direction. Each mcq set would feature 4 stem questions with 4 answers per set, whereby each each answer set would have at least 1 correct answer and at least 1 plausible distractor. With 4 stem questions per cycle, and 4 answers, of which at least one is correct, points toward an mcq score per user are distributed according to performance, evaluating answer correctness, answer completeness, promptitude, differential and answer retracements, per cycle involving 40 seconds.

### Answer Correctness

Each correct answer=1 point

Each incorrect answer=−1 point

### Score Differential

where there is a difference:
difference of 1 would count as 1 point for the user with most correct answers;
a positive difference of 2 would count as 3 points for said user with most correct answers;
a positive difference of 3 would count as 20 points for said user with most correct answers;
a positive difference of 4 would count as 100 points for said user with most correct answers;
the user with less correct answers does not get differential point credit.

### Promptitude

Total time per user is the time until they submit their answers. Regardless, the gameplay does not activate until the 40 seconds expires. Maximum total time is 40.

Total time per user is assessed involving formula of (40−total time)/3 and rounded to the nearest whole number, with each second equating to 1 point. If there is a difference between each user's score, the lesser number is subtracted from the larger number. The difference, equates to promptitude points. The user with the larger number is credited with the promptitude points and added to that user's subtotal. The user with the lesser number receives no promptitude points.

### Retracement

Retracement per question=−1 per incident

### Answer Completeness

unanswered question=−1

The points are added and equated to yardage whereby 45 points=45 yards. Such case would involve a playback of a gameplay of 45 yards for either user. If the 45 yards are earned by the user representing the offense, a gameplay of +45 yards would result. Inversely, if the 45 yards are earned by the user representing the defense, a gameplay of −45 yards would result.

As each presentation of an mcq set is not reused per game session, a timeout would result in a new mcq set. Either team is entitled to use a timeout for respective strategies. In any case that the user representing the offense fails to submit their answers before the 40 second time limit expires and without calling a timeout, a gameplay representing a delay of game would be activated depicting the penalty, and the field position tracked. Variations of illustrated algorithm would be scaled to depict adjustments involving situations that statistically involve more yardage, such as kickoff and punting situations which usually involve more open field running. Adjustments may involve relaxing the promptitude equation eliminating the divisor.

Aspects described herein illustrates the game flow for said video game. Coin Toss mcq 1 and assessment 2, equates to a coin toss before start of a football game enabling the winner to select their first role as an offensive stream or defensive team.

Kickoff mcq 3 and assessment 4, determines net yardage for matching and selection of commensurate gameplay involve in a kick-off situation. The assessment algorithm identifies the respective offensive and defensive teams and computes and tracks the field position, down number, and game score, game clock, and timeouts. Algorithm-selected gameplay is loaded from the library folder 33, and its associated script 36 from the script folder 34, executes to setup the neutral properties of the respective 3d characters in said gameplay to the respective user(s) defined character settings 35 including text-to-speech values 37 according to the properties set at pre-game. Said commensurate gameplay is displayed.

If the current Down number analyzed in item 5 or 6, is identified by said game algorithm to be 1st, 2nd, or 3rd, the 1st 2nd 3rd down mcq 7 is executed and displayed on the user's or users' control devices 26. Said 1st 2nd 3rd mcq 7 would be assessed 8 for a possible gameplay associated with the corresponding tracked Down number. As in the real game of football, results of possible net yardage per any given play could depict a gameplay ranging from an offensive or defensive touchdown score 10 or a defensive score 11, and net yardages in between. Item 8, assesses for possible results 9, 10, or 11, respective of the user's or users' mcq scores. Any resulting scoring gameplay would direct the game flow to the kickoff mcq 3 in case of safety, or directed by item 12 to point after mcq 31 in case of touchdown. If there is no scoring 9, the algorithm would track the Down number and possession 5 and direct the mcq flow to the 1st 2nd 3rd down mcq 7. Algorithm-selected commensurate gameplay 8 is loaded from the library folder 33 and its associated script 36 from the script folder 34, executes to setup the neutral properties of the respective 3d characters in said gameplay to the respective user(s) defined character settings 35 including text-to-speech values 37 according to the properties set at pre-game. Said commensurate gameplay 8 is displayed.

If the current Down number tracked by said game algorithm is 4, the 4th down mcq 14 is executed and displayed on the user's or users' control devices 26. Said 4th down mcq 14 would be assessed for a gameplay associated with possible 4th down plays. If in field goal range 15, mcq flow would direct to field goal mcq 16, which may flow to the field goal gameplay 18, or punt mcq 17, for possible flow to a punt gameplay 19. Possible offensive and defensive scoring, and all net yardage are analyzed, with outcome dependent on correlated and weighed assessment by the mcq scores to be translated into a commensurate gameplay. This may involve a missed field goal 20, a first down result 21 or a touchdown 22. Any resulting scoring gameplay, would direct the game flow to the kickoff mcq 3. All else would revert to the 1st 2nd 3rd down mcq 7 Algorithm-selected gameplay is loaded from the library folder and its associated script 36 from the script folder 34, executes to setup the neutral properties of the respective 3d characters in said gameplay to the respective user(s) defined character settings 35 including text-to-speech values 37 according to the properties set at pre-game. Said commensurate gameplay is displayed.

If previous gameplay resulted with a touchdown, the corresponding mcq 23 would display whose ensuing assessment would execute the algorithm accordingly, to display a commensurate gameplay 24 relating to the point after mcq 23. As with the other assessment variations depending on users' mcq scores, possible gameplays ranging from a 2 point conversion 24 by the offense to a 2 point score 24 by the defense are computed, accordingly and subject to the respective mcq assessment gameplay. Any resulting scoring gameplay 25, would direct the game flow to the kickoff mcq 3. All else would revert to the 1st 2nd 3rd down mcq 7. Commensurate gameplay is loaded from the library folder 33 and its associated script 36 from the script folder 34, executes to setup the neutral properties of the respective 3d characters in said gameplay to the respective user(s) defined character settings 35 including text-to-speech values 37, according to the properties set at pre-game Said commensurate gameplay is displayed.

The items illustrated in the respective drawing figures denote a linear flow of said video game. As any flow disruption affecting direction and ball possession could occur with any given play, as based on mcq scores, said game algorithm tracks ball possession, field position accordingly with each assessed mcq, and is able to direct game flow accordingly. As such, other details while executing playbacks of scripted gameplays, said game algorithm would direct the game flow to the Point After MCQ 31 (as due to touchdowns and scoring plays 10, 11), and/or Kick-off mcq 3 and 1st 2nd 3rd Down MCQ 7, accordingly, and as commensurate gameplays relative to mcq scores.

### BEST MODE OF IMPLEMENTATION

### Server System Requirements:

CPU 64 bit
2 GB Graphics card
Multi Core processor
16 GB Ram
Microsoft DotNetFramework
GLB file viewer
Rendering Software (3ds max)

1. A computer implemented video game for simulating the sport of American Football, as preferred embodiment, depicted with fluid lifelike animation comprising:
an expandable digital library of scripted pre-rendered animated gameplays depicting the sport of American Football whereby its animated characters are rendered utilizing rendering techniques not subject to real-time rendering constraints effecting representation of fluid lifelike motions in said gameplays, whereby said gameplays represent varieties and variations that may be necessary to depict said video game as a simulation of the sport of American Football, and whereby said gameplays may be activated and run without predictability of control;
a control implement utilizing an objective assessment method;
a process that displays objective assessment content;
a process that enables respective users to submit responses by wireless means via, by way of example and not limitation, client-server architecture;
a process that analyzes objective assessment responses to trigger activation or playback of commensurate gameplay with respect to said responses by said respective users;
a process of enabling respective users to customize text-to-speech content
for voice over narration featured on said gameplays;
a process that enables multi-user functionality,
a process that displays said gameplays whose contents may be unknown to respective users of said video game, whereby the contents of said gameplays are influenced by said users.

2. The method of claim 1 comprising:
an expandable digital library of educational content represented in objective assessment structure whereby said educational content may be represented accordingly in respective categories of varying educational levels for fostering learning.

3. A computer implemented video game for simulating the sport of American Football, as preferred embodiment, depicted with fluid lifelike animation comprising:
an expandable digital library of scripted pre-rendered animated gameplays depicting the sport of American Football whereby its animated characters are rendered utilizing rendering techniques not subject to real-time rendering constraints effecting representation of fluid lifelike motions in said gameplays, whereby said gameplays represent varieties and variations that may be necessary to depict said video game as a simulation of the sport of American Football, and whereby said gameplays may be activated and run without predictability of control;
a connection and configuration involving online gaming whereby a multi-user setting may be involved, and whereby said video game is executed by a computing machine operated by one of said user or users over a peer-to-peer network connection whereby said peer-to-peer connection may be configured, by way of example and not limitation, via Network address translation protocol (NAT) and NAT variations;
a control implement utilizing an objective assessment method;
a process that displays objective assessment content;
a process that enables respective users to submit responses by wireless means via, by way of example and not limitation, client-server architecture;
a process that analyzes objective assessment responses to trigger activation or playback of commensurate gameplay with respect to said responses by said respective users;
a process of enabling respective users to customize text-to-speech content for voice over narration featured on said gameplays;
a process that enables multi-user functionality,
a process that displays said gameplays whose contents may be unknown to respective users of said video game, whereby the contents of said gameplays are influenced by said users.

4. The method of claim 3 comprising:
an expandable digital library of educational content represented in objective assessment structure whereby said educational content may be represented accordingly in respective categories of varying educational levels for fostering learning.

5. A computer implemented video game for simulating the sport of American Football, as preferred embodiment, depicted with fluid lifelike animation comprising:
an expandable digital library of scripted pre-rendered animated gameplays depicting the sport of American Football whereby its animated characters are rendered utilizing rendering techniques not subject to real-time rendering constraints effecting representation of fluid lifelike motions in said gameplays, whereby said gameplays represent varieties and variations that may be necessary to depict said video game as a simulation of the sport of American Football, and whereby said gameplays may be activated and run without predictability of control;
a connection and configuration involving a remote server whereby said video game is run on a dedicated server that provides all necessary computing resources required by said video game;
a control implement utilizing an objective assessment method;
a process that displays objective assessment content;
a process that enables respective users to submit responses by wireless means via, by way of example and not limitation, client-server architecture;
a process that analyzes objective assessment responses to trigger activation or playback of commensurate gameplay with respect to said responses by said respective users;
a process of enabling respective users to customize text-to-speech content for voice over narration featured on said gameplays;
a process that enables multi-user functionality,
a process that displays said gameplays whose contents may be unknown to respective users of said video game, whereby the contents of said gameplays are influenced by said users.

6. The method of claim 5 comprising:
an expandable digital library of educational content represented in objective assessment structure whereby said educational content may be represented accordingly in respective categories of varying educational levels for fostering learning.

7. A computer implemented video game for simulating the sport of American Football, as preferred embodiment, depicted with fluid lifelike animation comprising:
an expandable digital library of scripted pre-rendered animated gameplays depicting the sport of American Football whereby its animated characters are rendered utilizing rendering techniques not subject to real-time rendering constraints effecting representation of fluid lifelike motions in said gameplays, whereby said gameplays represent varieties and variations that may be necessary to depict said video game as a simulation of the sport of American Football, and whereby said gameplays may be activated and run without predictability of control;
a control implement utilizing an objective assessment method;
a process that displays objective assessment content;
a process that enables respective users to submit responses by wireless means via, by way of example and not limitation, client-server architecture;
a process that analyzes objective assessment responses to trigger activation or playback of commensurate gameplay with respect to said responses by said respective users;
a process of enabling respective users to customize text-to-speech content for voice over narration featured on said gameplays;
a process that enables participation of a single to multiple users to represent a team per game session, whereby said participating user or users may be individually and respectively equipped with compatible controlling device involving said video game, whereby said user or users per team engages or engage in a competition, either against the computing machine executing said video game, or against another competing team, whereby said controlling devices in multi-user per team configuration are synchronously functional per team, whereby respective inputs are aggregated and consentaneously computed in accordance to game rules involving said video game,
a process that displays said gameplays whose contents may be unknown to respective users of said video game, whereby the contents of said gameplays are influenced by said users.

8. The method of claim 7 comprising:
an expandable digital library of educational content represented in objective
assessment structure whereby said educational content may be represented accordingly in respective categories of varying educational levels for fostering learning.

9. A computer implemented video game for simulating the sport of American Football, as preferred embodiment, depicted with fluid lifelike animation comprising:
a computer processor, a routing engine executing on the computer processor and configured to:
an expandable digital library of scripted pre-rendered animated gameplays depicting the sport of American Football whereby its animated characters are rendered utilizing rendering techniques not subject to real-time rendering constraints effecting representation of fluid lifelike motions in said gameplays, whereby said gameplays represent varieties and variations that may be necessary to depict said video game as a simulation of the sport of American Football, and whereby said gameplays may be activated and run without predictability of control;
a control implement utilizing an objective assessment method;
a process that displays objective assessment content;
a process that enables respective users to submit responses by wireless means via, by way of example and not limitation, client-server architecture;
a process that analyzes objective assessment responses to trigger activation or playback of commensurate gameplay with respect to said responses by said respective users;
a process of enabling respective users to customize text-to-speech content for voice over narration featured on said gameplays;
a process that enables multi-user functionality,
a process that displays said gameplays whose contents may be unknown to respective users of said video game, whereby the contents of said gameplays are influenced by said users.

10. The method of claim 9 comprising:
an expandable digital library of educational content represented in objective assessment structure whereby said educational content may be represented accordingly in respective categories of varying educational levels for fostering learning.

11. A non-transitory computer readable medium comprising a plurality of instructions for executing said video game depicting the sport of American Football, as preferred embodiment, the plurality of instructions comprising functionality to:
an expandable digital library of scripted pre-rendered animated gameplays depicting the sport of American Football whereby its animated characters are rendered utilizing rendering techniques not subject to real-time rendering constraints effecting representation of fluid lifelike motions in said gameplays, whereby said gameplays represent varieties and variations that may be necessary to depict said video game as a simulation of the sport of American Football, and whereby said gameplays may be activated and run without predictability of control;
a control implement utilizing an objective assessment method;
a process that displays objective assessment content;
a process that enables respective users to submit responses by wireless means via, by way of example and not limitation, client-server architecture;
a process that analyzes objective assessment responses to trigger activation or playback of commensurate gameplay with respect to said responses by said respective users;
a process of enabling respective users to customize text-to-speech content for voice over narration featured on said gameplays;
a process that enables multi-user functionality,
a process that displays said gameplays whose contents may be unknown to respective users of said video game, whereby the contents of said gameplays are influenced by said users.

12. The method of claim 11 comprising:
an expandable digital library of educational content represented in objective assessment structure whereby said educational content may be represented accordingly in respective categories of varying educational levels for fostering learning.
